(19) United States
(12) Patent Application Publication
(10) Pub. No.: US 2026/0150823 A1
(43) Pub. Date: Jun. 4, 2026

(54) Inline Rattling Fish Attractor

(71) Applicant: Sterling Sellers, Inc., Chattanooga, TN (US)

(72) Inventor: Daniel Leake, Chattanooga, TN (US)

(73) Assignee: Sterling Sellers, Inc., Chattanooga, TN (US)

(21) Appl. No.: 19/352,721

(22) Filed: Oct. 8, 2025

Related U.S. Application Data
(60) Provisional application No. 63/726,450, filed on Nov. 29, 2024.

(51) Int. Cl. A01K 85/01; A01K 85/00

(52) U.S. Cl. CPC A01K 85/017; A01K 85/1847; A01K 85/1851; A01K 85/1853

(57) ABSTRACT

The present invention discloses an inline rattling fish attractor that floats, added as a part to a fishing rig. The inline rattling fish attractor includes rattles inside that move to create sound and vibrations to attract fish to the rig. The rattles are positioned in strategic manner for creating rhythmic and continuous noise for attracting a lure. The trapped air creates a positively buoyant force underwater that lifts a fishing rig and bait off the bottom of a body of water.

### CLAIM OF PRIORITY

This application claims the benefit of US Provisional application No. 63/726,450 filed Nov. 29, 2024, which is incorporated herein by reference in its entirety.

### FIELD OF THE INVENTION

The present invention relates generally to the field of fishing lures. More particularly, the present invention relates to an inline rattling fish attractor equipped with rattles and floating structures that produce enhanced sound for attracting fish and lift a fishing rig off the bottom of a body of water.

### BACKGROUND OF THE INVENTION

Fishing is a very popular activity performed throughout the world for sport and food provision. One of the most important aspects of fishing is to attract a desired fish. Fishermen generally uses a fishing lure attached to a fishing pole to attract the fish to the lure. The fish must be enticed to attack and bite the lure or hook attached thereto in order for fishermen to be successful in catching the fish.

One of the prominent traditional ways to catch fish is to connect a hook to line connected to the pole and simply put a live bait on the hook, such that the motion of the live bait will attract the desired fish. Fish hooks are commonly used with baits. Examples of the live baits include live fish such as shad, herring, or sunfish. Fishermen also use non-live bait such as cut pieces of fish, pieces of chicken, various catfish dough and punch baits, or other artificial fishing lures. With both live and non-live or artificial baits or lures, various accessories are used to attract fish into the general vicinity, such as the realistic appearance of the fishing lure or the creation of noises or vibrations in the water to attract the fish. Artificial and live baits can be enhanced by adding strategic devices to include weight, illumination, audible sound, and or movement.

Rattles in particular are desirable to use when fishing. As the fishing rig is moved in the water, the rattle produces noise. Water is an excellent sound conductor. Fish are attracted to the noise. However, strategic add on devices, such as rattles can cause several problems for the purpose of attracting fish.

Floats such as a peg float made of foam are desirable to use when fishing with live, non-live, or artificial baits. Floats attached to the fishing line near the bait are buoyant and lift the bait and fishing rig off the bottom of the body of water, making it more available for a fish to eat. Lifting the fishing rig and hook in particular increases the availability of the bait to a fish, resulting in more successful fishing for fishermen.

A U.S. Pat. No. 4,995,189 assigned to Woodie's Cajun Lures Inc discloses a noise making fishing lure including a small two-piece shell assembly having two chambers therein. Each chamber contains a plurality of metal spheres which move as the lure is pulled through the water. The lure has an internal sleeve therein for receipt of a fishing line. However, the metal spheres and chamber are not shaped or aligned to produce noise when rotated. Additionally, the shape of the device is not meant to be a visual attractor when attached to fishing line. Additionally, the device does not trap adequate air to float a large piece of bait up in the water. This device is primarily for making a small amount of noise when inserted into a small bait such as a worm, rather than acting as a visual attractor and float.

Another US Publication 20170172125 discloses a fishing-lure enhanced rattle apparatus and method for use on a fishing line ahead of a fishing hook, having a resonant shell, resonant sleeve, and resonant beads making intermittent and repeating contact with each other and with the fishing line, generating sound patterns attractive to fish. Although, the fishing lure disclosed produces rhythmic or resonating sound for attracting fish, however, movement of resonant beads is caused in part by small variations in movement of the overall fishing line and the movement is also influenced by the flow of water through the resonant chamber. Additionally, this device is not shaped to be a realistic visual attractor for fish. Additionally, this device is designed to allow water to enter the device and would allow water to enter at deep water pressure, instead of trapping air at deep water pressure.

A U.S. Pat. No. 6,453,599 discloses a fishing lure having a body with two sections that move relative to one another. The body comprises a pair of body sections including a generally cylindrical fore section and a generally cylindrical aft section. The fore section and the aft section are both connected to the shaft. The shaft is inserted into the aft section's bore and secured thereto along a distal portion of the shaft by any suitable means. Although the fishing lure disclosed includes two sections, the fishing lure does not accommodate rattles and requires forward motion of the fishing line for the sections to impact each other and produce noise. Additionally, this device is not shaped to be a realistic visual attractor for fish. Additionally, this device requires fishing line to be tied to the front and back, instead of allowing continuous fishing line to pass through the entire device. These connecting points using knots can create a weakness in the fishing line, making the line more likely to break when fishermen are retrieving a fish. Additionally, this device is not meant to trap air or act as a buoy for the attached fishing rig.

A number of efforts in the prior art have been directed at providing a fishing lure that produces a rattling sound as it is moved through the water. However, the resulting lures have suffered from one or more of a number of disadvantages. One of these complications is many prior art lures require tying directly to a fishing line, instead of allowing continuous line to pass through the entire lure. This creates weak points in the fishing line. Another problem is not having an interior sound chamber of trapped air, shaped in a way that produces maximum noise when the lure is moved. Because of this, the lures do not attract fish with sound or vibrations. Another problem is many prior art are designed to be a noise producing device only, instead of also being shaped in a way that visually attracts fish also. Because of this, the lures do not visually attract fish. Another problem is many prior art is not intended to be a float or buoy to lift the fishing rig. Because of this, the lures do not lift the bait and hook in particular into an optimal position for a fish to bite. Another problem is the construction of prior art that is not intended to hold sufficient trapped air at deep water pressure. Because of this, the lures either are not buoyant, or allow water to penetrate into the interior.

Some devices aforementioned address only a single one of these issues, but there is not currently a device that solves all of issues collectively. Therefore, the present invention is designed to address the peculiar challenges in the prior art, the present invention discloses an inline rattling fish attractor including a strategic arrangement of a plurality of rattles that moves to create sound and vibrations to attract fish, visually attracts fish, and floats a fishing rig off the bottom even at deep water pressure and without requiring knots to attach to a fishing line.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Therefore, the present invention is designed to address the peculiar challenges in the existing devices on the market, as the present invention discloses an inline rattling fish attractor that produces enhanced sound due to positioning of rattles within a confined space.

### SUMMARY OF THE INVENTION

In accordance with the present invention, the disadvantages and limitations of the prior art are substantially avoided by providing an inline rattling fish attractor including a first end and a second end. Further, the inline rattling fish attractor is deployed over the fishing line in between the first end and the second end. The fishing line is a continuous line over which the inline rattling fish attractor is disposed on a piece of fishing line without requiring attachment by means of knots. The fishing line passes through the entire lure body in one continuous piece. The inline rattling fish attractor can slide along the fishing line, or be fixed in place with an existing stop. The existing stop may be a bobber stopper and alike.

The inline rattling fish attractor includes a right portion that includes a central channel for receiving the fishing line and a pair of channels above and below the central channel for holding a plurality of rattles. Further, the inline rattling fish attractor includes a left portion that is affixed to the right portion for securing the plurality of rattles. The left portions and the right portions include ends that are rounded in shape and the rounded ends are secured by a method to prevent water intrusion even at deep water pressure such as mechanical means, glue, ultrasonic adhesive means, or similar.

In preferred embodiment of the present invention, the left portions and the right portions include ends that are rounded in shape and the rounded ends are secured by ultrasound hardening or UV glue. The rounded ends prevent possible damage to the fishing line. In one embodiment of the present invention, the inline rattling fish attractor is made up of four plastic pieces. The central channel accommodates a two parts tube. In one alternative embodiment of the present invention, the inline rattling fish attractor is made up of three plastic pieces. The tube passing through the center is one piece tube.

The pair of channels includes a plurality of dividers for creating spaces for holding the plurality of rattles. In preferred embodiment of the present invention, each of the pair of channels includes three sections separated by two dividers creating three sections for holding the plurality of rattles. Further, the areas where the rattles are positioned includes at least one baffle or ridges for creating extra noises when the plurality of rattles impact or roll over the baffles or ridges. Further, when the inline rattling fish attractor shifts under various means such as water current passing over the exterior, the fishing rig being moved, live bait attached to the fishing rig swimming, or other means, the plurality of rattles moves to create sound and vibrations for attracting fish.

The inline rattling fish attractor further traps sufficient air in order to float the attached fishing line, hook, bait, and other attachments off the bottom of the body of water to make the bait more accessible to fish.

An objective of the present invention is to provide an inline rattling fish attractor that is hollow from inside to accommodate noise causing rattles for attracting lures.

Another objective of the present invention is to provide an inline rattling fish attractor that is shaped inside in such a way or include raised areas such as baffles for increasing the amount of the noise produced.

Yet another objective of the present invention is to provide an inline rattling fish attractor that is shaped in a way to attract fish visually. In one embodiment, the inline rattling fish attractor is shaped similarly to a bait fish that could be attractive to fish to eat. Along with this objective, the arrangement of the chambers and rattles are such that the inline rattling fish attractor maintains correct orientation similar to the bait it visually imitates.

Another objective of the present invention is to provide an inline rattling fish attractor that includes a trapped air chamber for making the inline rattling fish attractor to act as a floating buoy to lift the rest of the fishing rig.

Another objective of the present invention is to provide an inline rattling fish attractor that is made up of strong material and seam design, so that even at deep water pressure, no water can intrude into the trapped air chamber.

Other objectives and aspects of the invention will become apparent from the following detailed description, taken in conjunction with the accompanying drawings, which illustrate, by way for example, the features in accordance with embodiments of the invention.

To the accomplishment of the above and related objectives, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a side elevational view showing the inline rattling fish attractor in accordance with the present invention engaging with one embodiment of a fishing rig;

FIG. 2(A) illustrates a perspective view of an inline rattling fish attractor in accordance with the present invention;

FIG. 2(B) illustrates a perspective view of alternative embodiment of an inline rattling fish attractor in accordance with the present invention;

FIG. 3(A) illustrates a cross-sectional view of an inline rattling fish attractor focusing on a central channel through center of the inline rattling fish attractor, rattles and divider placement in accordance with the present invention; and

FIG. 3(B) illustrates a cross-sectional view of placement of rattles within a pair of channels in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

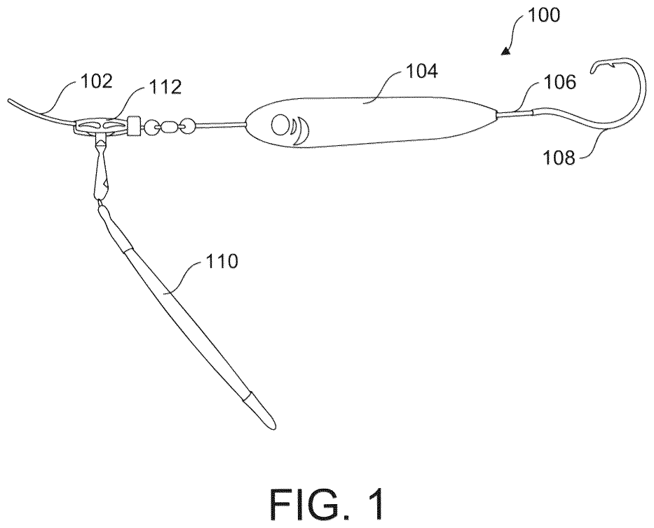

FIG. 1 illustrates a side elevational view showing the inline rattling fish attractor (104) in accordance with the present invention engaging with one embodiment of a fishing rig. The inline rattling fish attractor (104) is placed on a continuous piece of fishing line (106) near a fishing hook (108) where bait can be attached. The fishing line (106) passes through the entire lure body in one continuous piece. The inline rattling fish attractor (104) can slide along the fishing line (102), or be fixed in place with an existing stop. The existing stop may be a bobber stopper and alike. A fishing sinker (110) is placed on the fishing line (102). When lowered into the water, the sinker (110) rests in a lower position, and the inline rattling fish attractor (104) floats and also elevates the fishing rig (100), especially the hook (108) off the bottom of the body of water and into a position optimal for access by a fish.

In one embodiment of the present invention, the inline rattling fish attractor is made up of four plastic pieces. The central channel accommodates a two parts tube. In one alternative embodiment of the present invention, the inline rattling fish attractor is made up of three pieces. The tube through the center is one piece. The pair of channels includes a plurality of dividers for creating spaces or air tight cavities for holding the plurality of rattles. In preferred embodiment of the present invention, each of the pair of channels includes three sections separated by two dividers creating three sections for holding the plurality of rattles.

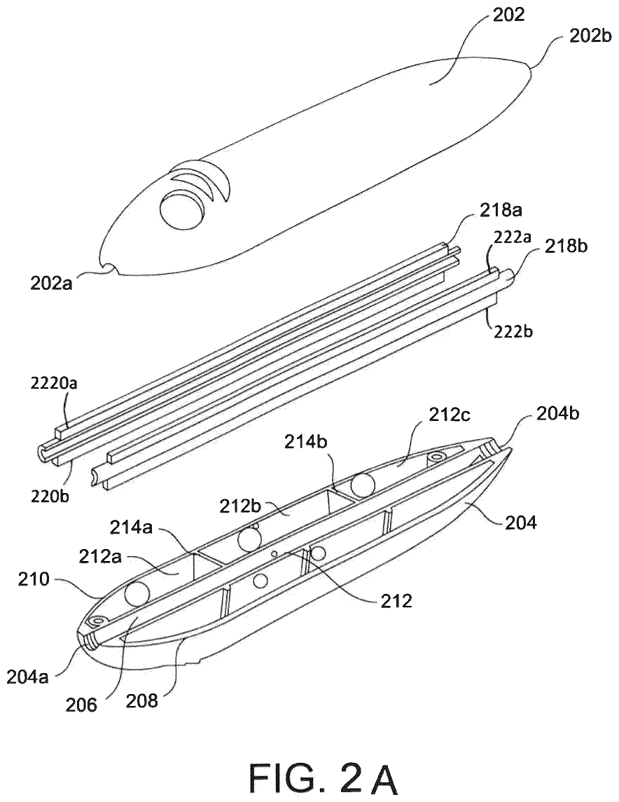

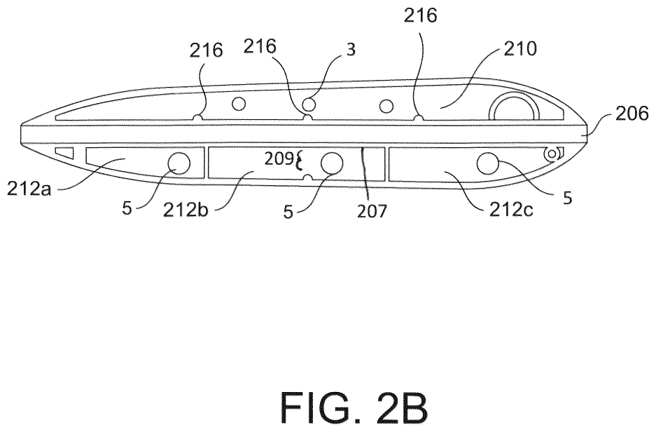

FIG. 2(A) illustrates a perspective view of an inline rattling fish attractor (104) in accordance with the present invention. The inline rattling fish attractor (104) includes a left portion (202) and a right portion (204) opposite to the left portion (202). The left and right portions (202,204) may be symmetrical relative to one another.

The inline rattling fish attractor (104) includes left portion (202) and right portion (204) that are disposed about a central channel (206) for receiving the fishing line (106) and, for the illustrated embodiment, combine to provide first and second areas (208, 210) above and below central channel (206) for holding a plurality of rattles (3 or 5). Further, the inline rattling fish attractor (104) includes the left portion (202) that is affixed to the right portion (204) for securing the plurality of rattles (3 or 5). The left portion (202) and the right portion (204) include left portion ends (202A, 202B) and right portion ends (204A, 204B). The ends (202A, 202B, 204A, 204B) are rounded in shape and the rounded ends (202A, 202B, 204A, 204B) may be secured by ultrasound hardening or UV glue. The rounded ends (202A, 202B, 204A, 204B) may assist in preventing possible damage to the fishing line.

At least one of the first and second areas (208 or 210) may include a plurality of dividers for creating air tight cavities for holding the plurality of rattles. In preferred embodiment of the present invention, the second area (210) is located below the first areas 208 and includes three air tight cavities, first second and third air tight cavities (212A, 212B, 212C) separated and spaced apart by two dividers (214A, 214B) creating three sections for holding the plurality of rattles (3 or 5). The first air tight cavity is in front of the second air tight cavity which is in front of the third air tight cavity. Further, the upper, or first area (210) includes at least one baffle or ridges (216) for creating extra noises when the plurality of rattles (3 or 5) rolls around. Second air tight cavity 212B is shown with a ridge as well. Ridges 216 extend upwardly from a bottom of the respective first or second areas (208,210) toward an upper surface 207 of the respective first and second areas (208,210) while being spaced by a gap 209. Gap has a length which exceeds a height of a rattle (3 or 5), such as a diameter of a spherical shaped rattle (3 or 5, illustrated).

Air tight cavities (212A, 212B, 212C and/or 214A,214B) may provide positive buoyancy to assist having the fish attractor (104) float. First and second areas (208,210) may each comprise at least 40% of the volume of the fish attractor (104).

Further, when the inline rattling fish attractor (104) floats or moves, the plurality of rattles move to create sound and vibrations for attracting fish. In one embodiment of the present invention, the inline rattling fish attractor is made up of four plastic pieces. The central channel accommodates a two parts tube. The two parts tube includes a pair of tube halves (218A, 218B) for supporting the central channel. Wings (220A,220B) and (222A,222B) extend from tube halves (218A,218B) for some embodiments. Wings may extend horizontally and/or parallel to the ridges (216).

FIG. 2(B) illustrates a perspective view of alternative embodiment of the inline rattling fish attractor in accordance with the present invention. In one alternative embodiment of the present invention, the inline rattling fish attractor is made up of three plastic pieces. The tube through the center is one piece.

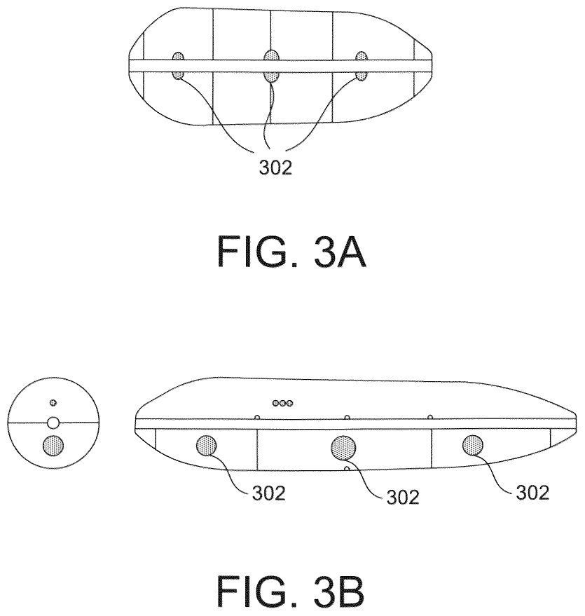

FIG. 3(A) illustrates a cross-sectional view of an inline rattling fish attractor (104) focusing on a central channel (206) through center of the inline rattling fish attractor (104), rattles and divider placement in accordance with the present invention. Each of the pair of channels (208, 210) includes three sections (212A, 212B, 212C) separated by two dividers (214A, 214B) creating three sections for holding the plurality of rattles. Further, the upper portion (210) includes at least one baffle or ridges (216) for creating extra noises when the plurality of rattles rolls around. Further, when the inline rattling fish attractor (104) floats, the plurality of rattles moves to create sound and vibrations for attracting fish. Each section (214A, 214B, 214C) includes ridges or bumps to cause the extra noise when the rattles move back and forth. In one embodiment of the present invention, the plurality of rattles is either of bead, balls, metal balls and alike. The diameter of plurality of rattles ranges from 3 mm to 10 mm.

FIG. 3(B) illustrates a cross-sectional view of placement of rattles within a pair of channels in accordance with the present invention. The horizontal divider accommodates at least three smallest balls in the upper section. Each section of the three lower sections (214A, 214B, 214C) accommodates beads or ball of diameter ranges from 6 mm to 8 mm.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A fish attractor comprising:
a left and right portion forming an elongate body extending from a front to a back;
a channel extending from the front to the back of the elongate body configured to receive a fishing line therethrough;
a first area located in a top half of the elongate body having at least one air tight cavity with at least one rattle therein;
a second area located in a bottom half of the elongate body having at least one air tight cavity with at least one rattle therein spaced from the first area;
wherein at least one of the first and second areas have a ridge extending upwardly from a bottom surface into the cavity, said ridge spaced from an upper surface of the cavity by a gap, the gap greater than a height of the at least one rattle, thereby permitting the at least one rattle to pass through the gap under certain angular relationships of the inline fishing attractor, and
the inline rattling fish attractor is positively bouyant to assist in moving at least some of the rattles for creating sound and vibrations for attracting fish.

2. The fish attractor of claim 1 wherein the channel is a centrally disposed channel through the elongate body.

3. The fish attractor of claim 2 wherein the channel is within a tube located between the left and right portions.

4. The fish attractor of claim 3 wherein the tube is formed of first and second tube parts.

5. The fish attractor of claim 4 wherein the first and second tube parts respectively have wings extending radially outwardly therefrom, said wings extending parallel to the ridge.

6. The fish attractor of claim 4 wherein first and second tube parts have wings which extend horizontally relative to the tube.

7. The fish attractor of claim 1 wherein the left and right portions are symmetrical relative to each other.

8. The fish attractor of claim 7 wherein the first and second areas are asymmetrical relative to one another.

9. The fish attractor of claim 1, wherein the second area has at least one divider separating a first and second cavity, with the first cavity located in front of the second cavity, and both the first and second cavities having at least one rattle.

10. The fish attractor of claim 9 wherein one of the first and second cavities has an upwardly extending ridge.

11. The fish attractor of claim 1 wherein the first area has smaller rattles than are in the second area.

12. The fish attractor of claim 1 wherein the at least one air tight cavity in the second area has at least a first and a second air tight cavity in the second area separated from one another, and the first air tight area being in front of the second air tight cavity.

13. The fish attractor of claim 1 wherein the at least one air tight cavity in the second area has a third air tight cavity in the second area separated from the first and second air tight cavities, and the third air tight area being behind the second air tight cavity.

14. A fish attractor comprising:
a left and right portion forming an elongate body extending from a front to a back;
a channel extending from the front to the back of the elongate body configured to receive a fishing line therethrough;
a first area located in a top half of the elongate body having at least one air tight cavity with at least one rattle therein;
a second area located in a bottom half of the elongate body having at least two air tight cavities, each with at least one rattle therein spaced apart from the first area with a first of the at least two air tight cavities separated from a second of the at least two air tight cavities and located forward of any portion of the second of the at least two air tight cavities;
wherein the inline rattling fish attractor is positively bouyant to assist in moving at least some of the rattles for creating sound and vibrations for attracting fish.

15. The fish attractor of claim 14 wherein at least one of the first and second areas have a ridge extending upwardly from a bottom surface one of the first and second areas, said ridge spaced from an upper surface of the first one of the first and second areas by a gap, the gap greater than a height of the at least one rattle, thereby permitting the at least one rattle to pass through the gap under certain angular relationships of the inline fishing attractor.

16. The fish attractor of claim 15 wherein the first area has the ridge and at least two rattles in the first area.

17. The fish attractor of claim 14 wherein the left and right sides are symmetric relative to one another.

18. The fish attractor of claim 14 wherein the first and second areas each encompass over 40%, respectively of the fish attractor.

19. The fish attractor of claim 14 further comprising a third air tight cavity in the second area separated from the first and second air tight cavities and located behind the second air tight cavity.

20. The fish attractor of claim 14 wherein the at least one rattles are spherically shaped.
